(19) United States
(12) Patent Application Publication
(10) Pub. No.: US 2002/0004900 A1
(43) Pub. Date: Jan. 10, 2002

(54) METHOD FOR SECURE ANONYMOUS COMMUNICATION

(76) Inventor: BAIJU V. PATEL, PORTLAND, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/148,107

(22) Filed: Sep. 4, 1998

(51) Int. Cl. H04L 9/32

(52) U.S. Cl. 713/155

(57) ABSTRACT

Secure anonymous communication between a first party and a second party is accomplished by establishing an identity of the first party with a third party, obtaining an anonymous certificate having a selected attribute by the first party from the third party, and presenting the anonymous certificate by the first party to the second party for verification to establish the anonymous communication.

### BACKGROUND

1. Field

The present invention relates generally to data communications and more specifically to secure communications between computer systems.

2. Description

The rise in the use of computer networks, such as the Internet, for example, has opened up new ways for people and organizations to communicate. This communication requires, at times, transmitting sensitive or confidential information over a computer network. It thus becomes imperative to be able to conduct private, tamper-proof communication with known parties. To bring this about, organizations have built secure communications infrastructures based on public key cryptography using digital certificates.

A digital certificate is a digital representation of information that is signed by a trusted third party. A trusted third party is an organization of demonstrable probity offering auditable services in the field of validation, authentication, and assurance. The digital certificate represents the certification of an individual, business or organizational public key. It can also be used to show the privileges and roles for which the certificate holder has been certified. An important aspect of a digital certificate is that there may be an operational period that is attached to the certificate implying that the certificate expires. The information in a digital certificate is typically laid out following an International Telecommunication Union (ITU) standard called X.509 which contains at least three main sets of information. The subject name and attribute information (also called the distinguished name) contains details of the person that has applied for the certificate. The public key information contains information that forms part of the public/private key pair for matching the distinguished name (i.e., it is a copy of the certificate holder's public key). The certifying authority signature contains the identity of a trusted third party and the trusted third party's digital signature to affirm that the digital certificate was issued by a valid agency. A digital signature can be used to assure a reader of a non-repudiable information source. A digital signature is a logical hash (mathematical summary) of information enciphered using an asymmetric key unique to the signer.

In order to securely exchange information or verify digital signatures, one must be able to identify the association of a public key. Digital certificates provide a mechanism to bind an identity and attributes to a public key. With digital certificates, the trusted third party is responsible for verifying a set of credentials of a person according to a pre-defined policy. If approved, the public key and the credentials are digitally encoded and signed using the trusted third party's private key to form a certificate. The certificate can then be distributed in a public manner, and the identity associated with a public key can be authenticated by verifying the signature on the certificate. In this way digital certificates are used to verify the authenticity, roles, privileges, and limitations of the private key holder associated with the public key within the certificate. This level of verification is necessary for electronic commerce and secure communications.

Digital certificates may be issued by entities called Certificate Authorities (CAs). Certificate Authorities control public key infrastructures (PKIs). A CA manages a PKI, issues certificates and establishes PKI policies within its domain. Prior to issuing a certificate, the CA must first validate the information provided in a certification request according to a pre-defined policy. For example, one CA's policy may require two forms of photographic identification of the certificate requester, a social security number, birth certificate, and a background check, while another CA's policy may only require that the certificate requester possess a unique electronic mail address. For this reason, although the signature on a digital certificate may be valid, trust can only be established if the CA's policy is accepted by the recipient of the certificate.

By using digital certificates, clients within a client/server environment (such as the Internet, for example) can be assured of a server's identity because the server may prove its identity by presenting a certificate. A user who connects to a web site, for example, that has a server certificate signed by a trusted third party can be confident that the server is actually operated by the company identified in the certificate. Similarly, certificates enable servers to be confident of a client's identity. When a user connects to a web site, the server can be assured of the user's identity if the server receives the client's certificate. Hence, digital certificates form the basis for secure, authenticated communication and access control on the Internet and on intranets.

Under some circumstances, a user may desire to retain anonymity during secure communications over the Internet or an intranet. Instead of full certification, a user may want to have attributes associated with the user be certified to another party without disclosure of the user's identity. However, existing public key infrastructures do not provide for this type of communication. Therefore, a need exists for a method of providing secure anonymous communication over a computer network using digital certificates.

### SUMMARY

An embodiment of the present invention is a method for secure anonymous communication between a first party and a second party. The method includes establishing an identity with a third party, obtaining an anonymous certificate having a selected attribute from the third party, and presenting the anonymous certificate to the second party to establish the anonymous communication.

Another embodiment of the present invention is a method of providing a secure anonymous certificate to a first party by a third party. The method includes requesting information corresponding to at least one personal attribute of the first party, receiving the information from the first party, establishing an account for the first party with the information, providing the first party with credentials for accessing the account, receiving a request for an anonymous certificate having a selected attribute and the credentials from the first party, verifying an identity of the first party using the credentials, and creating the anonymous certificate asserting the selected attribute of the first party.

Another embodiment of the present invention is a method for secure anonymous communication between a first party and a second party. The method includes receiving a request for communication from a first party, requesting proof of a selected attribute of the first party, receiving an anonymous certificate asserting the selected attribute, verifying the selected attribute, and allowing the anonymous communication.

### BRIEF DESCRIPTION OF THE DRAWINGS

The features and advantages of the present invention will become apparent from the following detailed description of the present invention in which:

FIG. 1 is a diagram illustrating a sample computer system suitable to be programmed according to an embodiment of a method for secure anonymous communication;

FIG. 2 is a diagram of the relationships between a certificate authority, a vendor or other content provider, and a user according to one embodiment of the present invention;

FIG. 3 is a flow diagram of a process for secure anonymous communication according to an embodiment of the present invention;

FIG. 4 is a flow diagram of a process for establishing a personal account and identity with a certificate authority according to an embodiment of the present invention;

FIG. 5 is a flow diagram of a process for requesting and obtaining an anonymous certificate selecting at least one attribute according to an embodiment of the present invention; and

FIG. 6 is a flow diagram of a process using the anonymous certificate to obtain access to desired content or to complete a desired transaction according to an embodiment of the present invention.

### DETAILED DESCRIPTION

In the following description, various aspects of the present invention will be described. For purposes of explanation, specific numbers, systems and configurations are set forth in order to provide a thorough understanding of the present invention. However, it will also be apparent to one skilled in the art that the present invention may be practiced without the specific details. In other instances, well known features are omitted or simplified in order not to obscure the present invention.

Embodiments of the present invention may be implemented in hardware or software, or a combination of both. However, embodiments of the invention may be implemented in computer programs executing on programmable computer systems comprising at least one processor, a data storage system (including volatile and non-volatile memory and/or storage elements), at least one input device, and at least one output device. Program code may be applied to input data to perform the functions described herein and generate output information. The output information may be applied to one or more output devices, in known fashion.

The programs may be implemented in a high level procedural or object oriented programming language to communicate with the computer system. The programs may also be implemented in assembly or machine language, if desired. In fact, the invention is not limited in scope to any particular programming language. In any case, the language may be a compiled or interpreted language.

The computer programs may be stored on a storage media or device (e.g., hard disk drive, floppy disk drive, read only memory (ROM), CD-ROM device, flash memory device, digital versatile disk (DVD), or other storage device) readable by a general or special purpose programmable computer system, for configuring and operating the computer system when the storage media or device is read by the computer system to perform the procedures described herein. Embodiments of the invention may also be considered to be implemented as a machine-readable storage medium, configured for use with a computer system, where the storage medium so configured causes the computer system to operate in a specific and predefined manner to perform the functions described herein.

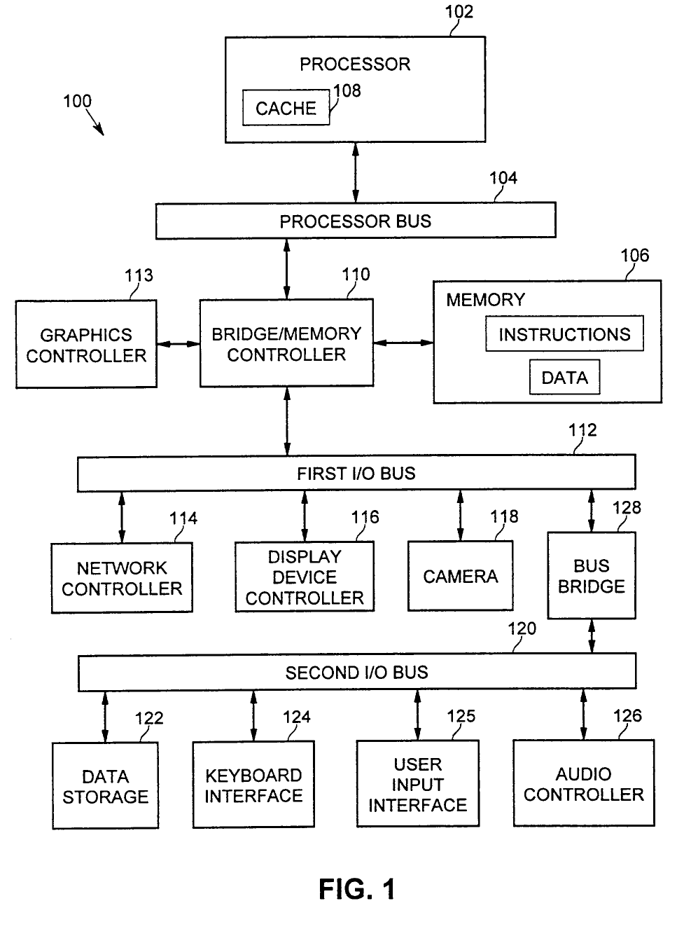

An example of one such type of computer system is shown in FIG. 1. Sample system 100 may be used, for example, to execute the processing for the methods described herein. Sample system 100 is representative of computer systems based on the PENTIUM®, PENTIUM® Pro, and PENTIUM® II microprocessors available from Intel Corporation, although other systems (including personal computers (PCs) having other microprocessors, engineering workstations, set-top boxes and the like) may also be used. In one embodiment, sample system 100 may be executing a version of the WINDOWS™ operating system available from Microsoft Corporation, although other operating systems and graphical user interfaces may also be used.

FIG. 1 is a block diagram of a computer system 100 upon which an embodiment of the present invention may be implemented. The computer system 100 includes a processor 102 that processes data signals. The processor 102 may be a complex instruction set computer (CISC) microprocessor, a reduced instruction set computing (RISC) microprocessor, a very long instruction word (VLIW) microprocessor, a processor implementing a combination of instruction sets, or other processor device. FIG. 1 shows an example of an embodiment of the present invention implemented on a single processor computer system 100. However, it is understood that embodiments of the present invention may be implemented in a computer system having multiple processors. The processor 102 may be coupled to a processor bus 104 that transmits data signals between processor 102 and other components in the computer system 100.

The computer system 100 includes a memory 106. The memory 106 may be a dynamic random access memory (DRAM) device, a static random access memory (SRAM) device, or other memory device. The memory 106 may store instructions and/or data represented by data signals that may be executed by the processor 102. The instructions and/o data comprise the code for performing any and/or all of the techniques of the present invention. The memory 106 may also contain additional software (not shown). A cache memory 108 may reside inside processor 102 that stores data signals stored in memory 106. The cache memory 108 speeds up memory accesses by the processor by taking advantage of its locality of access. Alternatively, the cache memory may reside external to the processor.

A bridge/memory controller 110 may be coupled to the processor bus 104 and the memory 106. The bridge/memory controller 110 directs data signals between the processor 102, the memory 106, and other components in the computer system 100 and bridges the data signals between the processor bus 104, the memory 106, and a first input/output (I/O) bus 112. In some embodiments, the bridge/memory controller provides a graphics port (e.g., an Accelerated Graphics Port (AGP)) for connecting to a graphics controller 113. The graphics controller 113 interfaces to a display device (not shown) for displaying images rendered or otherwise processed by the graphics controller 113 to a user. The display device may be a television set, a computer monitor, a flat panel display, or other suitable display device.

The first I/O bus 112 may be a single bus or a combination of multiple buses. The first I/O bus 112 provides communication links between components in computer system 100. A network controller 114 may be coupled to the first I/O bus 112. The network controller links the computer system 100 to a network of computers (not shown in FIG. 1) and supports communication among various computer systems. The network of computers may be a local area network (LAN), a wide area network (WAN), the Internet, or other computer network. In some embodiments, a display device controller 116 may be coupled to the first I/O bus 112. The display device controller 116 allows coupling of a display device to the computer system 100 and acts as an interface between a display device (not shown) and the computer system. The display device controller may be a monochrome display adapter (MDA) card, a color graphics adapter (CGA) card, an enhanced graphics adapter (EGA) card, an extended graphics array (XGA) card, or other display device controller card. The display device may be a television set, a computer monitor, a flat panel display, or other suitable display device. The display device receives data signals from the processor 102 through the display device controller 116 and displays information contained in the data signals to a user of the computer system 100.

A camera 118 may be coupled to the first I/O bus. The camera 118 may be a digital video camera having internal digital video capture hardware that translates a captured image into digital graphical data. The camera may be an analog video camera having digital video capture hardware external to the video camera for digitizing a captured image. Alternatively, the camera 118 may be a digital still camera or an analog still camera coupled to image capture hardware. A second I/O bus 120 may be a single bus or a combination of multiple buses. The second I/O bus 120 provides communication links between components in the computer system 100. A data storage device 122 may be coupled to the second I/O bus 120. The data storage device 122 may be a hard disk drive, a floppy disk drive, a CD-ROM device, a flash memory device, or other mass storage device. Data storage device 122 may comprise one or a plurality of the described data storage devices.

A keyboard interface 124 may be coupled to the second I/O bus 120. The keyboard interface 124 may be a keyboard controller or other keyboard interface device. The keyboard interface 124 may be a dedicated device or may reside in another device such as a bus controller or other controller device. The keyboard interface 124 allows coupling of a keyboard to the computer system 100 and transmits data signals from a keyboard to the computer system 100. A user input interface 125 may be coupled to the second I/O bus 120. The user input interface may be coupled to a user input device such as a mouse, joystick, or trackball, for example, to provide input data to the computer system. An audio controller 126 may be coupled to the second I/O bus 120. The audio controller 126 operates to coordinate the recording and playback of audio signals. A bus bridge 128 couples the first I/O bridge 112 to the second I/O bridge 120. The bus bridge operates to buffer and bridge data signals between the first I/O bus 112 and the second I/O bus 120.

Embodiments of the present invention are related to the use of the computer system 100 to provide secure anonymous communication over a computer network. According to one embodiment, secure anonymous communication may be performed by the computer system 100 in response to the processor 102 executing sequences of instructions in memory 104. Such instructions may be read into memory 104 from another computer-readable medium, such as data storage device 122, or from another source via the network controller 114, for example. Execution of the sequences of instructions causes the processor 102 to provide secure anonymous communication over a computer network, as will be described hereafter. In an alternative embodiment, hardware circuitry may be used in place of or in combination with software instructions to implement embodiments of the present invention. Thus, the present invention is not limited to any specific combination of hardware circuitry and software.

These elements perform their conventional functions well-known in the art. In particular, data storage device 122 may be used to provide long-term storage for the executable instructions for embodiments of methods for secure anonymous communication over a computer network in accordance with the present invention, whereas memory 106 is used to store on a shorter term basis the executable instructions of embodiments of the methods for secure anonymous communication over a computer network in accordance with the present invention during execution by processor 102.

An embodiment of the present invention is a method of issuing anonymous credentials to a user that guarantee a set of user attributes and a method of using those credentials to establish an anonymous and secure communication channel. The anonymous certificate (AC) may comprise identifying a user's personal attributes such as age, citizenship, financial status, geographic location, educational or employment status, and so on. One possible use of such credentials is to control access to content available on a computer network, such as the Internet, for example, based only on those attributes.

For example, access to any software that uses strong encryption is controlled by United States export control laws. Only U.S. citizens or permanent residents are allowed access to this class of software. Therefore, any vendor intending to make such software available on the Internet, for example, should ensure that each customer meets these requirements prior to closing a transaction. A digital certificate may be used to authenticate the user's citizenship status. However, a person obtaining the software may also want to protect his or her identity from the vendor. Hence, using an AC would be ideal in this situation. In another example, some content available on the Internet should not be accessible to minors. Therefore, the vendor or other provider of such content must ensure that the user accessing the content is not a minor. The AC may be used to authenticate the user's age by having the age as an attribute of the AC. At the same time, the user may want to protect his or her identity. In a third example, bidders in an auction may want to remain anonymous. However, the auctioneer wants to ensure that a bidder has the financial means of paying for the purchased items. Therefore, the financial information of the user (bidder) may be an attribute of the AC. Using this anonymous certificate, the bidder can participate in the auction. Later, the payments may be made, perhaps by electronic cash or electronic funds transfer (EFT). However, if the bidder fails to make payment, under a court order the auctioneer could go to the anonymous certificate authority who issued the AC and obtain the identity of the bidder. These examples illustrate the utility of embodiments of the present invention. Of course, the present invention is not limited to these examples and many other uses are possible.

An anonymous certificate (AC) is a digital certificate where the distinguished name field appears to be random. It may be computationally impractical to determine the identity of the holder of the certificate from the distinguished name. An AC may have one of at least two classes of distinguished names. The first class represents a random number, and the second class represents a globally unique identifier (ID). When a random number is used for the identity of the certificate holder, only the issuer (i.e., the certificate authority (CA)) and the holder of the certificate know the mapping between the holder's identity and the anonymous certificate. The CA does not know when and how the AC will be used (or even if it is used at all). However, the CA encodes the appropriate fields of the AC so that when the AC is presented, the receiver may verify the attributes associated with the certificate. If the receiver trusts the issuer of the certificate, then the receiver may verify the attributes associated with the holder of the certificate, without learning the identity of the certificate holder.

In many cases, it may be desirable for the distinguished name to be a unique ID associated with the user instead of a random number. For example, this ID may be generated by cryptographic hash (e.g., using the MD5 or SHA processes, for example) one or more attributes of the user such as name, place of residence, telephone number, age, social security number, mother's maiden name, etc. This technique allows for the possibility that a third party may establish whether a certain entity used the anonymous certificate or not. For example, if law enforcement agencies suspect that a certain user was involved in selected communications activities, it may be possible for the agencies to generate the unique ID based on known information about the user and to determine if the generated ID matches the distinguished name in the anonymous certificate used in those activities. At the same time, it may be very difficult for someone to randomly determine if any user used a particular AC.

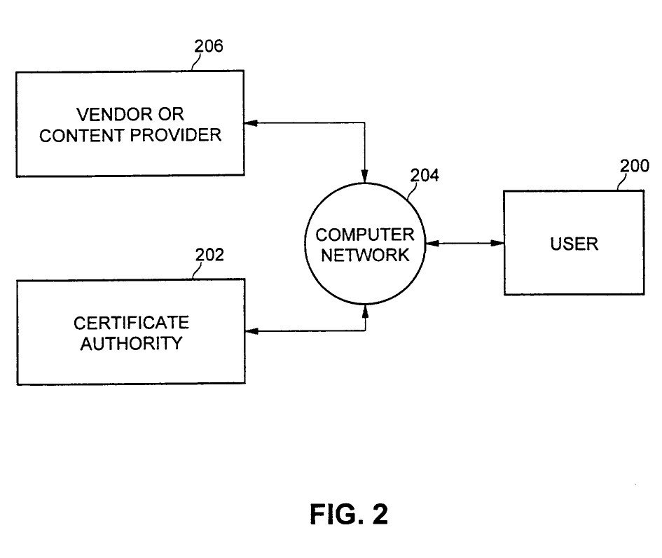

Secure anonymous communication according to embodiments of the present invention comprises a two step process: 1) obtain an anonymous certificate that includes desired user attributes from a trusted certificate authority, and 2) use the anonymous certificate for secure communication. For this method to be effective, a trust relationship must exist between the two end points of the secure communication channel and the certificate authority. FIG. 2 is a diagram of the relationships between a certificate authority, a vendor or other content provider, and a user. A user 200 may contact a certificate authority 202 for an AC via a computer network 204 such as the Internet, for example. The user supplies certain attribute information in his or her request. In response, the CA supplies the AC containing those attributes. Once the user has the AC, he or she may present the AC to a vendor or content provider 206 for anonymous but secure access to the vendor's data or system. This communication may be protected using well-known Internet Engineering Task Force (IETF) methods such as IP security protocol (IPSEC) or Secure Socket Layer Protocol (SSL).

In one embodiment, there exists a certificate-based trust relationship between the user and the certificate authority. This relationship may be implemented by well-known methods, such as those commercially available from VeriSign, Inc. Using this trust relationship, the user establishes a secure communication channel (e.g., SSL or IPSEC) with the certificate authority. Then, over this channel, the user requests an anonymous certificate and supplies the necessary attribute information. The CA may perform additional checks on the data supplied by the user, and issues an AC comprising the attribute information to the user. Based on the type of information contained and the risks associated with it, the AC may have a very short to a long validity. For example, age (as an attribute of the user) does not decrease with time and therefore, an AC with age as an attribute may have a long validity period. In another example, financial status or wealth may go down with time. Therefore, an AC including financial information (for example, for use in bidding in an auction) may have a very short validity period.

The user then uses the AC to establish a secure anonymous communication channel with a server computer system of a vendor or content provider to complete a transaction using a well-known secure communication protocol. Examples of such protocols include Internet Protocol (IP) Security Protocols (IPSEC) and Secure Sockets Layer (SSL). In order to make this work, the vendor or content provider may securely publish (e.g., using SSL—Hyper Text Transfer Protocol Security (HTTPS)), information about the anonymous certificate authorities that it trusts, and the attribute values required for access to the vendor's services. This step ensures that the user may first determine which CA to use and what attributes are to be specified in a request for an AC from a CA for subsequent presentation to a vendor or content provider.

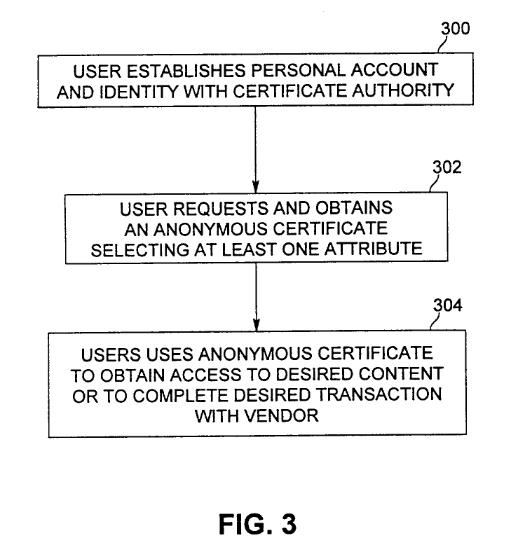

FIG. 3 is a flow diagram of a process for secure anonymous communication according to one embodiment of the present invention. In a first phase represented as block 300, a user establishes a personal account and identity with a certificate authority (CA). In a second phase represented as block 302, the user requests and obtains an anonymous certificate (AC) selecting at least one attribute. In a third phase represented as block 304, the user uses the anonymous certificate to obtain access to desired content or to complete a desired transaction by presenting the AC to the vendor.

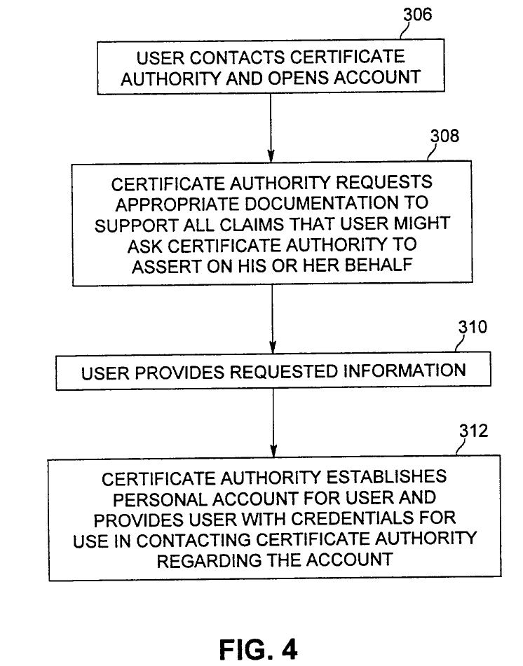

FIG. 4 is a flow diagram of a process for establishing a personal account and identity with a certificate authority. At block 306, the user contacts the certificate authority and opens a personal account. At block 308, the certificate authority requests appropriate documentation to support all claims that the user might ask the certificate authority to assert on his or her behalf. The documentation may comprise various items such as birth certificates, driver's licenses, proof of residency, proof of employment or educational status, financial statements, etc. The documentation supports various attributes that may be authenticated by the certificate authority in an anonymous certificate. At block 310, the user provides the requested information. At block 312, the certificate authority establishes a personal account for the user and provides the user with credentials for use in contacting the certificate authority regarding the account. The credentials may comprise, for example, a password a personal identification number (PIN), or a digital certificate (note that this certificate need not be an anonymous certificate because the CA needs to know the identity of the user in order to issue an AC later on demand.

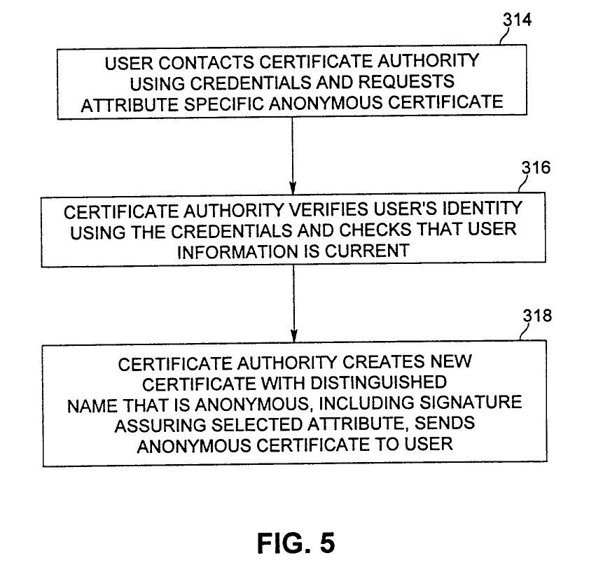

FIG. 5 is a flow diagram of a process for requesting and obtaining an anonymous certificate selecting at least one attribute. At block 314, the user contacts the certificate authority using the credentials provided in block 312 and requests an attribute specific anonymous certificate. At block 316, the certificate authority verifies the user's identity using the credentials and checks that the user's information is current. At block 318, the certificate authority creates a new certificate with a distinguished name that is anonymous (either a random name or a globally unique ID as discussed above), including the certificate authority's digital signature assuring the selected attribute, and sends the anonymous certificate to the user.

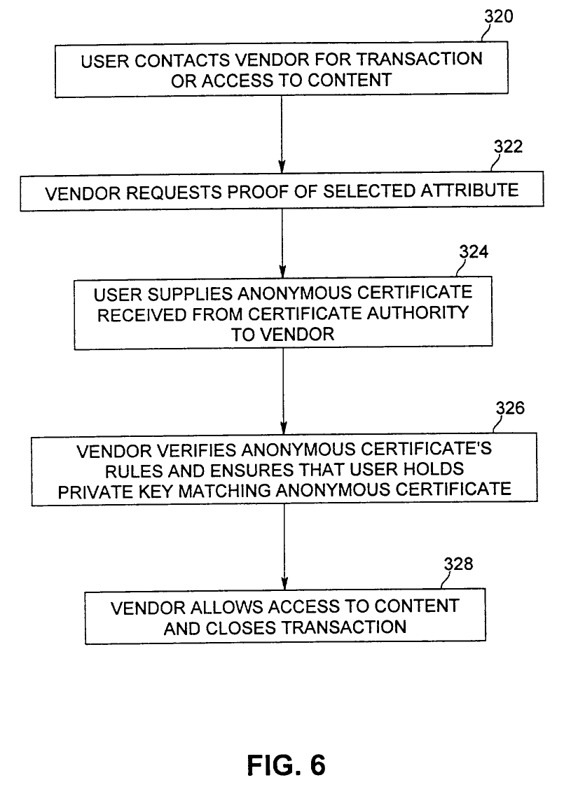

FIG. 6 is a flow diagram of a process using the anonymous certificate to obtain access to desired content or to complete a desired transaction. At block 320, the user contacts a vendor or content provider to complete a transaction or to gain access to protected content. In one embodiment, this block comprises connecting to a web site over the Internet and requesting access to protected content or indicating a purchase of a vendor's product. At block 322, the vendor replies to the user's request by requesting proof of a selected attribute (e.g., age, citizenship, etc.). At block 324, the user supplies the anonymous certificate received from the certificate authority to the vendor. The anonymous certificate asserts that the user has the selected attribute's value. At block 326, the vendor verifies the anonymous certificate's rules (such as expiration date, appropriate attribute values, etc.) and ensures that the user holds the private key matching the anonymous certificate. The methods of authenticating users based on the certificates are an integral part of secure communication protocols. For example, the Internet Key Exchange (IKE) protocol, which is part of the IPSEC protocol, or SSL authentication mechanisms may be used to perform the function of ensuring that the user holds the right private key. If these verifications are successful, the vendor allows access to the requested content or completes and then closes the transaction at block 328.

While this invention has been described with reference to illustrative embodiments, this description is not intended to be construed in a limiting sense. Various modifications of the illustrative embodiments, as well as other embodiments of the invention, which are apparent to persons skilled in the art to which the inventions pertains are deemed to lie within the spirit and scope of the invention.

What is claimed is:

1. A method for secure anonymous communication between a first party and a second party comprising:
establishing an identity with a third party;
obtaining an anonymous certificate having a selected attribute from the third party; and
presenting the anonymous certificate to the second party to establish the anonymous communication.

2. The method of claim 1, wherein the anonymous certificate comprises a distinguished name field having a random number representing the first party.

3. The method of claim 1, wherein the anonymous certificate comprises a distinguished name field having a globally unique identifier representing the first party.

4. The method of claim 3, wherein the globally unique identifier comprises a hash of at least one attribute of the first party.

5. The method of claim 1, wherein establishing an identity comprises:
establishing an account with the third party; and
providing information corresponding to personal attributes of the first party.

6. The method of claim 1, wherein obtaining the anonymous certificate comprises:
requesting the anonymous certificate having the selected attribute; and
receiving the anonymous certificate.

7. The method of claim 1, wherein presenting the anonymous certificate comprises:
contacting the second party to establish anonymous communication; and
supplying the anonymous certificate in response to requested proof of the selected attribute.

8. The method of claim 1, wherein the anonymous communication comprises accessing, by the first party, selected content controlled by the second party.

9. The method of claim 1, wherein the anonymous communication comprises engaging in a transaction between the first party and the second party.

10. A method of providing a secure anonymous certificate to a first party by a third party comprising:
requesting information corresponding to at least one personal attribute of the first party;
receiving the information from the first party;
establishing an account for the first party with the information;
providing the first party with credentials for accessing the account;
receiving a request for an anonymous certificate having a selected attribute and the credentials from the first party;
verifying an identity of the first party using the credentials; and
creating the anonymous certificate asserting the selected attribute of the first party.

11. The method of claim 10, wherein the anonymous certificate comprises a digital signature of the third party.

12. The method of claim 10, wherein the anonymous certificate comprises a distinguished name field having a random number representing the first party.

13. The method of claim 10, wherein the anonymous certificate comprises a distinguished name field having a globally unique identifier representing the first party.

14. The method of claim 13, wherein the globally unique identifier comprises a hash of at least one attribute of the first party.

15. A method for secure anonymous communication between a first party and a second party comprising:
receiving a request for communication from a first party;
requesting proof of a selected attribute of the first party;
receiving an anonymous certificate asserting the selected attribute;
verifying the selected attribute; and
allowing the anonymous communication.

16. The method of claim 15, further comprising ensuring that the first party holds a private key matching the anonymous certificate.

17. The method of claim 15, wherein the anonymous communication comprises accessing, by the first party, selected content controlled by the second party.

18. The method of claim 15, wherein the anonymous communication comprises engaging in a transaction between the first party and the second party.

19. The method of claim 15, wherein the anonymous certificate comprises a distinguished name field having a random number representing the first party.

20. The method of claim 15, wherein the anonymous certificate comprises a distinguished name field having a globally unique identifier representing the first party.

21. An article comprising:
a machine readable medium having a plurality of machine readable instructions, wherein when the instructions are executed by a processor the instructions cause a first party to establish an identity with a third party, to obtain an anonymous certificate having a selected attribute from the third party; and to present the anonymous certificate to a second party to establish secure anonymous communication between the first party and the second party.

22. The article of claim 21, wherein the secure anonymous communication comprises accessing, by the first party, selected content controlled by the second party.

23. The article of claim 21, wherein the secure anonymous communication comprises engaging in a transaction between the first party and the second party.

24. An article comprising:
a machine readable medium having a plurality of machine readable instructions, wherein when the instructions are executed by a processor the instructions cause a third party to request information corresponding to at least one personal attribute of a first party, to receive the information from the first party, to establish an account for the first party with the information, to provide the first party with credentials for accessing the account, to receive a request for an anonymous certificate having a selected attribute and the credentials from the first party, the anonymous certificate to be used for secure anonymous communication with a second party, to verify an identity of the first party using the credentials, and to create the anonymous certificate asserting the selected attribute of the first party.

25. The article of claim 24, wherein the instructions to create the anonymous certificate comprise instructions to insert a digital signature of the third party into the anonymous certificate.

26. The article of claim 24, wherein the instructions to create the anonymous certificate comprise instructions to insert a distinguished name field having a random number representing the first party into the anonymous certificate.

27. The article of claim 24, wherein the instructions to create the anonymous certificate comprise instructions to insert a distinguished name field having a globally unique identifier representing the first party into the anonymous certificate.

28. An article comprising:
a machine readable medium having a plurality of machine readable instructions, wherein when the instructions are executed by a processor the instructions cause a second party to receive a request for communication from a first party, to request proof of a selected attribute of the first party, to receive an anonymous certificate asserting the selected attribute, to verify the selected attribute, and to allow secure anonymous communication between the first party and the second party.

29. The article of claim 28, wherein the secure anonymous communication comprises accessing, by the first party, selected content controlled by the second party.

30. The article of claim 28, wherein the secure anonymous communication comprises engaging in a transaction between the first party and the second party.

31. A system for secure anonymous communication comprising:
a first party to establish an identity, to obtain an anonymous certificate having a selected attribute corresponding to the first party, and to present the anonymous certificate to establish the secure anonymous communication;
a second party to request the anonymous certificate having the selected attribute and to allow secure anonymous communication between the first party and the second party when the selected attribute is verified; and
a third party to request information corresponding to at least one personal attribute of the first party, the at least one personal attribute comprising the selected attribute, to receive the information from the first party, to receive a request for an anonymous certificate having the selected attribute from the first party, and to create the anonymous certificate asserting the selected attribute of the first party based on the established identity.

32. The system of claim 31, wherein the secure anonymous communication comprises accessing, by the first party, selected content controlled by the second party.

33. The system of claim 31, wherein the secure anonymous communication comprises engaging in a transaction between the first party and the second party.
